(19) United States
(12) Patent Application Publication
(10) Pub. No.: US 2024/0066984 A1
(43) Pub. Date: Feb. 29, 2024

(54) ELECTRIC VEHICLE AND CRUISE CONTROL METHOD THEREFOR

(71) Applicants: HYUNDAI MOTOR COMPANY, Seoul (KR); KIA CORPORATION, Seoul (KR)

(72) Inventors: Sung Jae Oh, Hwaseong-si (KR); Hui Un Son, Suwon-si (KR); Seok Min Jeong, Suwon-si (KR); Jin Kyeom Cho, Suwon-si (KR)

(21) Appl. No.: 18/099,040

(22) Filed: Jan. 19, 2023

(30) Foreign Application Priority Data
Aug. 31, 2022 (KR) 10-2022-0109977

(51) Int. Cl. B60K 31/00; B60L 15/20

(52) U.S. Cl. CPC B60K 31/0008; B60L 15/20; B60K 2031/0016; B60L 2240/12; B60L 2240/423; B60L 2240/647

(57) ABSTRACT

An electric vehicle and a cruise control method therefore are capable of improving ride comfort by reducing a pitch caused by a road surface deceleration factor. A method of controlling a smart cruise control function includes determining a target speed of a vehicle that is traveling when a road surface deceleration factor in front of the vehicle is detected, entering the road surface deceleration factor while traveling at a constant speed corresponding to the determined target speed, and performing pitch reduction control upon entering the road surface deceleration factor.

### CROSS REFERENCE TO RELATED APPLICATIONS

This application is based on and claims priority under 35 U.S.C. § 119 to Korean Patent Application No. 10-2022-0109977, filed on Aug. 31, 2022, in the Korean Intellectual Property Office, the disclosure of which is herein incorporated by reference in its entirety.

### BACKGROUND

### 1. Field

The present disclosure relates to an electric vehicle capable of improving ride comfort by reducing a pitch caused by a road surface deceleration factor, and a cruise control method therefore.

### 2. Description of the Related Art

A cruise control function refers to a function of automatically maintaining a set target speed without operating the accelerator pedal until a specific condition such as brake operation is satisfied when a driver sets the target speed. This cruise control function has been developed into a smart cruise control (SCC) function with the development of sensor technology.

The smart cruise control function performs control based on a distance and a relative speed to a preceding vehicle using a front radar sensor and can perform acceleration/deceleration depending on the distance to the preceding vehicle while following the target speed. In the case of a general smart cruise control function, speed control is performed according to a target speed if a distance to a preceding vehicle is long compared to a relative speed, and distance control is performed if the distance is short compared to the relative speed. Emergency braking may be performed when the distance is excessively short compared to the relative speed.

Speed bumps are installed on roads in order to forcibly lower running speeds of vehicles, and white and yellow reflectors are coated thereon to distinguish them from roads according to laws and regulations and the lengths thereof may vary depending on the widths of roads. When a vehicle passes over such a speed bump at a high speed, longitudinal weight tilting due to acceleration/deceleration occurs and a pitch caused by the amount of tilting is generated, and thus ride comfort may be deteriorated and the lifespan of the vehicle may be reduced.

However, the general smart cruise control function controls a vehicle using a distance and a relative speed to a preceding vehicle without consideration of speed bumps, as described above. Therefore, when the preceding vehicle accelerates after passing over a speed bump, the vehicle performs acceleration control regardless of the speed bump according to distance control in order to narrow the distance to the preceding vehicle, which causes deterioration of ride comfort when passing over the speed bump.

In addition, when a vehicle passes over a speed bump, the smart cruise control function is frequently canceled due to the operation of a traction control system (TCS), which is one of the functions of the vehicle, and vehicle wheel slip operation. In such a situation, the driver needs to reduce the vehicle speed and reset the smart cruise control function, which is cumbersome.

Accordingly, a method of applying control considering speed bumps to the smart cruise control function has been proposed. This will be described with reference to FIGS. 1 and 2.

FIGS. 1 and 2 are diagrams for describing problems of the general smart cruise control function. FIGS. 1 and 2 show behavior of a vehicle over time. As shown in FIG. 1, the general smart cruise control function based on recognition of a speed bump 30 rapidly reduces the vehicle speed before the vehicle enters the speed bump when the speed bump 30 is detected. However, even if deceleration is performed, there is a problem that the smart cruise control function is canceled due to the aforementioned wheel slip or the like. In this case, inconvenience and fuel efficiency decrease due to resetting of the smart cruise control function after passing over the speed bump 30 occur.

Furthermore, as shown in FIG. 2, even if pitch reduction control is introduced into the smart cruise control function, it aims to reach a target speed immediately before entering the speed bump 30, and thus nose-down occurs due to braking before a vehicle enters the speed bump 30 and nose-up occurs due to acceleration for pitch reduction when the vehicle enters the speed bump, which deteriorates ride comfort. In addition, since a braking profile needs to be separately processed before and after entering the speed bump 30, a problem of inconvenience is generated.

### SUMMARY

Therefore, the present disclosure has been made in view of the above problems, and it is an object of the present disclosure to provide an electric vehicle and a cruise control method therefor capable of reducing a pitch caused by a road surface deceleration factor in the front of a vehicle to improve ride comfort and extend the lifespan of the vehicle and reducing the frequency of driver intervention due to cancelation of smart cruise control.

The technical issues to be achieved in the present disclosure are not limited to the technical issues mentioned above, and other technical issues which are not mentioned will be clearly understood by those of ordinary skill in the art to which the present disclosure belongs from the description below.

In accordance with the present disclosure, the above and other objects can be accomplished by the provision of a method of controlling a smart cruise control function, including determining a target speed of a vehicle that is traveling when a road surface deceleration factor in front of the vehicle is detected, entering the road surface deceleration factor while traveling at a constant speed corresponding to the determined target speed, and performing pitch reduction control upon entering the road surface deceleration factor.

For example, the road surface deceleration factor may be detected through at least one of a navigation system, lidar, radar, ultrasonic waves, or a camera.

For example, the method may further include traveling at a constant speed corresponding to the target speed again after passing over the road surface deceleration factor.

For example, the method may further include performing the smart cruise control function at a set target speed before a road surface deceleration factor is detected after traveling at the constant speed again.

For example, the performing pitch reduction control may include determining a pitch rate according to the road surface deceleration factor, and performing pitch reduction control through motor torque control on the basis of the determined pitch rate.

For example, the pitch reduction control may be performed when preset control entry conditions are satisfied.

For example, the method may further include stopping the determination and performing additional deceleration if a prohibition condition is additionally satisfied when the preset control entry conditions are satisfied.

For example, the method may further include determining a distance to the road surface deceleration factor, and performing speed control to the target speed on the basis of the determined distance such that the vehicle is able to travel at a constant speed corresponding to the target speed for a predetermined time before entering the road surface deceleration factor.

For example, the road surface deceleration factor may include at least one of a speed bump or a pothole.

In accordance with another aspect of the present disclosure, there is provided an electric vehicle providing a smart cruise control function, including a first controller configured to determine a target speed of a vehicle that is traveling when a road surface deceleration factor in front of the vehicle is detected, and a second controller configured to control the vehicle such that the vehicle enters the road surface deceleration factor while traveling at a constant speed corresponding to the determined target speed and to perform pitch reduction control when the vehicle enters the road surface deceleration factor.

For example, the second controller may be configured to control the vehicle such that the vehicle travels at a constant speed corresponding to the target speed again after passing over the road surface deceleration factor.

For example, the first controller may include a smart cruise controller, and the second controller may be configured to switch control of the smart cruise control function to the first controller when a set target speed is reached before a road surface deceleration factor is detected after the traveling at the constant speed.

For example, the second controller may be configured to determine a pitch rate according to the road surface deceleration factor and to perform pitch reduction control through motor torque control on the basis of the determined pitch rate.

For example, the second controller may be configured to perform pitch reduction control when preset control entry conditions are satisfied.

For example, the second controller may be configured to stop the determination and to perform additional deceleration if a prohibition condition is additionally satisfied when the preset control entry conditions are satisfied.

For example, the first controller may be configured to determine a distance to the road surface deceleration factor and to perform speed control to the target speed on the basis of the determined distance such that the vehicle is able to travel at a constant speed corresponding to the target speed for a predetermined time before entering the road surface deceleration factor.

### BRIEF DESCRIPTION OF THE FIGURES

The above and other objects, features and other advantages of the present disclosure will be more clearly understood from the following detailed description taken in conjunction with the accompanying drawings, in which:

FIGS. 1 and 2 are diagrams for describing problems of a general smart cruise control function;

FIG. 3 shows an example of a configuration of a powertrain of an electric vehicle according to an embodiment of the present disclosure;

FIG. 4 shows an example of a configuration of a control system of the electric vehicle according to an embodiment of the present disclosure;

FIG. 5 is a block diagram of a smart cruise control system according to an embodiment of the present disclosure;

FIGS. 6 and 7 are diagrams for describing target speed determination and pitch reduction control of a vehicle in smart cruise control according to an embodiment of the present disclosure;

FIG. 8 is a graph showing pitch reduction control on/off of a second controller according to an embodiment of the present disclosure; and

FIG. 9 is a flowchart illustrating an example of a smart cruise control process according to an embodiment of the present disclosure.

### DETAILED DESCRIPTION

Hereinafter, embodiments disclosed in the present specification will be described in detail with reference to the accompanying drawings, but the same or similar components are denoted by the same reference numerals and redundant descriptions thereof will be omitted. The suffixes “module” and “part” of elements herein are used for convenience of description and thus can be used interchangeably and do not have any distinguishable meanings or functions. In the following description of the embodiments disclosed in the present specification, a detailed description of known functions and configurations incorporated herein will be omitted when it may obscure the subject matter of the present disclosure. In addition, the accompanying drawings are provided only for ease of understanding of the embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

In addition, unit or control unit included in the names of a motor control unit (MCU), a hybrid control unit (HCU), and the like is only a term widely used to name a controller that controls a specific vehicle function and does not mean a generic functional unit. For example, each controller may include a communication device that communicates with other controllers or sensors to control functions of the controller, a memory that stores an operating system or logic commands and input/output information, and one or more processors that perform determination, operation, and decision necessary to control the functions.

Prior to description of a smart cruise control method according to embodiments of the present disclosure, the structure and control system of an electric vehicle applicable to the embodiments will be described first.

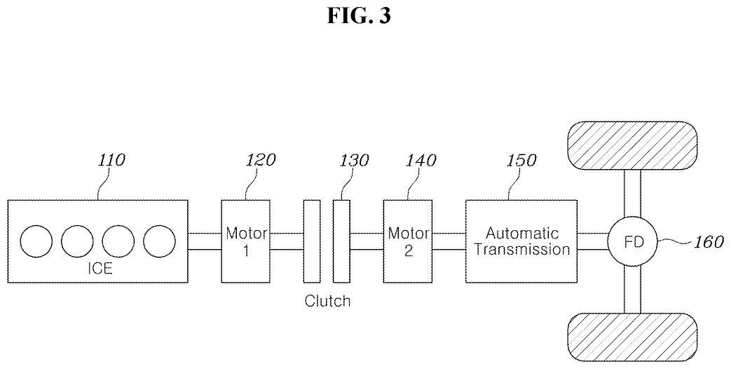

FIG. 3 shows an example of a configuration of a powertrain of an electric vehicle according to an embodiment of the present disclosure.

FIG. 3 shows a powertrain of an electric vehicle adopting a parallel type hybrid system in which two motors 120 and 140 and an engine clutch 130 are provided between an internal combustion engine (ICE) 110 and a transmission 150. This parallel hybrid system is also called a transmission mounted electric drive (TMED) hybrid system because the motor 140 is always connected to the input terminal of the transmission 150.

Here, the first motor 120 between the two motors 120 and 140 may be disposed between the engine 110 and one end of the engine clutch 130, and the engine shaft of the engine 110 and the first motor shaft of the first motor 120 may be directly connected to each other and rotate together at all times.

One end of the second motor shaft of the second motor 140 may be connected to the other end of the engine clutch 130, and the other end of the second motor shaft may be connected to the input end of the transmission 150.

The second motor 140 may have higher power than the first motor 120 and may serve as a driving motor. In addition, the first motor 120 executes a function of a starter motor for cranking the engine 110 when the engine 110 is started, may recover the rotational energy of the engine 110 through power generation when the engine is off, and may perform power generation with the power of the engine 110 while the engine 110 is in operation.

When the driver depresses the accelerator pedal after starting (e.g., HEV Ready) in an electric vehicle having the powertrain as shown in FIG. 3, the second motor 140 is driven first using the power of a battery (not shown) in a state in which the engine clutch 130 is opened. Accordingly, the power of the second motor 140 is applied through the transmission 150 and a final reducer (FD) 160 to move the wheels (i.e., EV mode). When higher driving power is required as the vehicle gradually accelerates, the first motor 120 may operate to crank the engine 110.

When the difference between the rotational speeds of the engine 110 and the second motor 140 is within a certain range after the engine 110 is started, the engine clutch 130 is engaged and thus the engine 110 and the second motor 140 rotate together (i.e., transition from the EV mode to the HEV mode). Accordingly, the power of the second motor 140 decreases and the power of the engine 110 increases through a torque blending process, thereby satisfying a required torque of the driver. In the HEV mode, the engine 110 may satisfy most of the required torque, and the difference between the engine torque and the required torque may be compensated through at least one of the first motor 120 or the second motor 140. For example, when the engine 110 outputs a torque higher than the required torque in consideration of the efficiency of the engine 110, the first motor 120 or the second motor 140 generates power by the engine torque surplus, and when the engine torque is lower than the required torque, at least one of the first motor 120 or the second motor 140 may output a torque shortage.

When preset engine off conditions are satisfied, such as when the vehicle is decelerated, the engine clutch 130 is opened and the engine 110 is stopped (i.e., transition from the HEV mode to the EV mode). During deceleration, the battery is charged through the second motor 140 using the driving force of the wheels, which is referred to as braking energy regeneration or regenerative braking.

As the transmission 150, a stepped transmission or a multi-plate clutch, for example, a dual-clutch transmission (DCT) may be generally used.

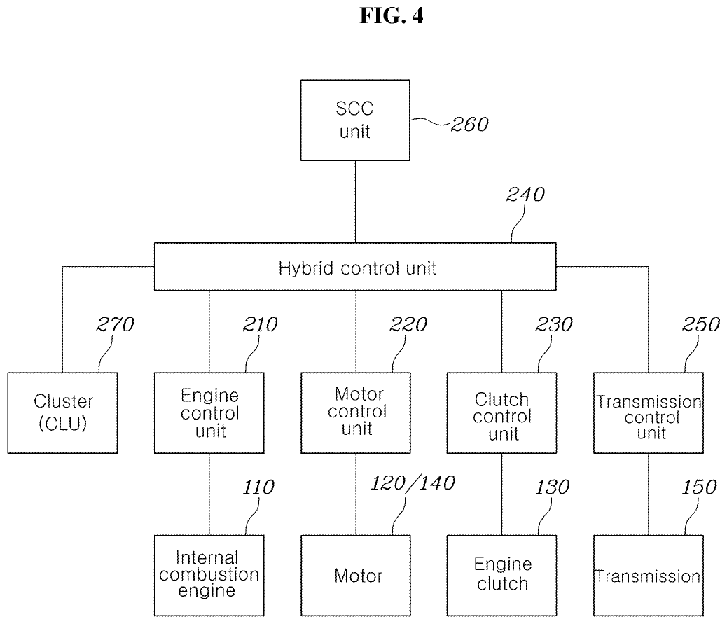

FIG. 4 shows an example of a configuration of a control system of the electric vehicle according to an embodiment of the present disclosure

Referring to FIG. 4, in the electric vehicle to which embodiments of the present disclosure can be applied, the internal combustion engine 110 is controlled by an engine control unit 210, the torques of the first motor 120 and the second motor 140 may be controlled by a motor control unit (MCU) 220, and the engine clutch 130 may be controlled by a clutch control unit 230. Here, the engine control unit 210 is also referred to as an engine control system (EMS). In addition, the transmission 150 is controlled by a transmission control unit 250.

The motor control unit 220 may control a gate drive unit (not shown) on the basis of the motor angle, phase voltage, phase current, and required torque of each of the motors 120 and 140 using a pulse width modulation (PWM) control signal, and accordingly the gate driving unit may control an inverter (not shown) that drives the motors 120 and 140.

Each control unit may be connected to a hybrid control unit (HCU) 240 that controls the overall powertrain including a mode conversion process as a higher control unit and may provide information necessary for driving mode change and engine clutch control during gear shifting and/or information necessary for engine stop control to the hybrid control unit 240 or perform an operation according to a control signal according to control of the hybrid control unit 240.

For example, the hybrid control unit 240 determines whether to perform switching between EV-HEV modes or CD-CS modes (in the case of PHEV) according to a driving state of the vehicle. To this end, the hybrid control unit determines when the engine clutch 130 is released (opened) and performs hydraulic control when the engine clutch 130 is released. In addition, the hybrid control unit 240 may determine the state (lock-up, slip, open, etc.) of the engine clutch 130 and control fuel injection stop timing of the engine 110. Further, the hybrid control unit may transmit a torque command for controlling the torque of the first motor 120 to the motor control unit 220 for engine stop control to control engine rotational energy recovery. In addition, the hybrid control unit 240 may determine the states of the drive sources 110, 120 and 140 in order to satisfy the required torque, determine a required drive force to be shared by the drive sources 110, 120 and 140 according to the states, and transmit a torque command to the control units 210 and the 220 that control the drive sources. In a state in which the smart cruise control function is executed, the hybrid control unit 240 may determine a required torque according to an acceleration/deceleration request of a smart cruise control unit 260. In addition, the transmission 150 is controlled by the transmission control unit 250. Further, the smart cruise control unit 260 may generate an acceleration/deceleration request on the basis of sensor information such as information on a camera sensor and a radar sensor and a set target vehicle speed. In addition, a cluster 270 may provide various control states transmitted from the hybrid control unit 240 to the driver.

It is apparent to those skilled in the art that the above-described connection relationship between the control units and the function/classification of each control unit are exemplary and are not limited to the names. For example, the hybrid control unit 240 may be implemented such that the functions thereof are provided by any one of the other control units or the functions are provided by two or more of the other control units in a distributed manner.

It will be apparent to those skilled in the art that the configuration of FIGS. 3 and 4 described above is merely an example of the configuration of an electric vehicle and an electric vehicle applicable to the embodiments is not limited to this structure.

In the embodiments of the present disclosure, in a situation in which the smart cruise control function is activated, the position of a road surface deceleration factor is detected, the vehicle is controlled to travel at a constant speed corresponding to a target speed before reaching the road surface deceleration factor, and control for reducing a pitch caused by longitudinal weight tilting is performed to improve driver's ride comfort.

The road surface deceleration factor mentioned in the present disclosure may mean a bump 30, for example, a speed bump, which causes a decrease in the driver's ride comfort due to an uneven surface when a vehicle passes thereover without sufficient deceleration. However, this is an example and the road surface deceleration factor is not necessarily limited thereto. For example, the deceleration factor may include an uneven road surface or a damaged road surface such as a pothole. In the following description, for convenience, the road surface deceleration factor will be referred to as a “bump.” In addition, the bump 30 may be detected by a lidar sensor, a radar sensor, an ultrasonic sensor, and a camera sensor capable of measuring a distance to a front object, or may be detected by a communication device including a navigation device.

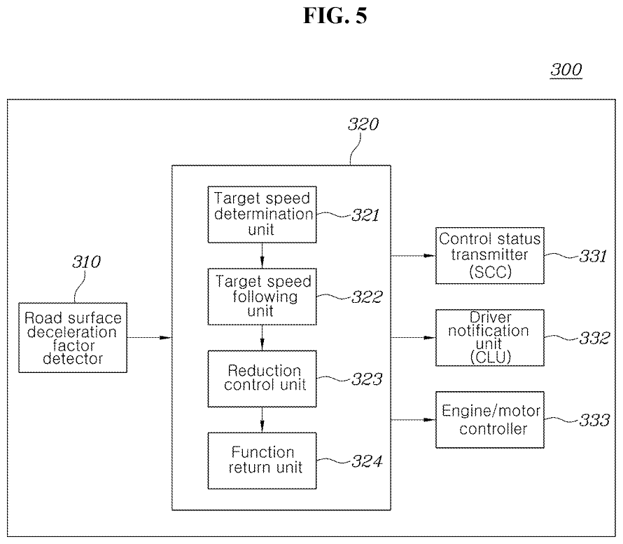

FIG. 5 is a block diagram illustrating a smart cruise control system 300 according to an embodiment of the present disclosure. Referring to FIG. 5, the smart cruise control system 300 according to an embodiment includes a bump detector 310, a vehicle controller 320, a control status transmitter 331 for transmitting a smart cruise control status, a driver notification unit (cluster) 332 for notifying a driver of a control state of the vehicle controller 320, and an engine/motor controller 333 for controlling the engine 110 and the motor 140 by receiving a torque command corresponding to a required torque determined by the hybrid control unit 240.

More specifically, the vehicle controller 320 may include a target speed determination unit 321 that determines a target speed of smart cruise control, a target speed following unit 322 that allows a vehicle to enter the bump 30 by traveling at a constant speed corresponding to the determined target speed, a reduction control unit 323 that performs pitch reduction control when the vehicle enters the bump 30 at the target speed, and a function return unit 324 that returns to smart cruise control at the target speed after passing over the bump 30.

Here, the smart cruise control unit 260 may be in charge of the target speed determination unit 321, and the hybrid control unit 240 that determines a required torque in a situation requiring intervention on the basis of a determined target speed may be in charge of the target speed following unit 322, the reduction control unit 323, and the function return unit 324.

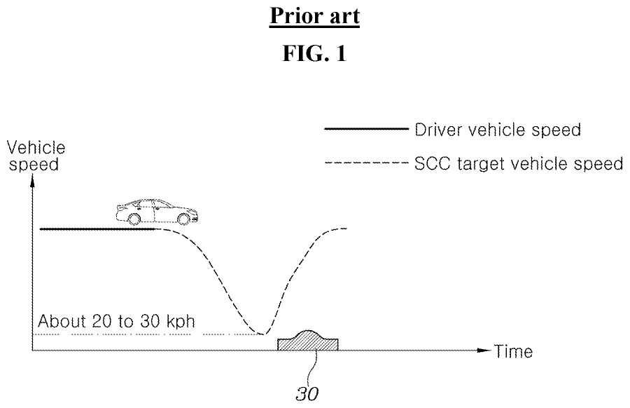

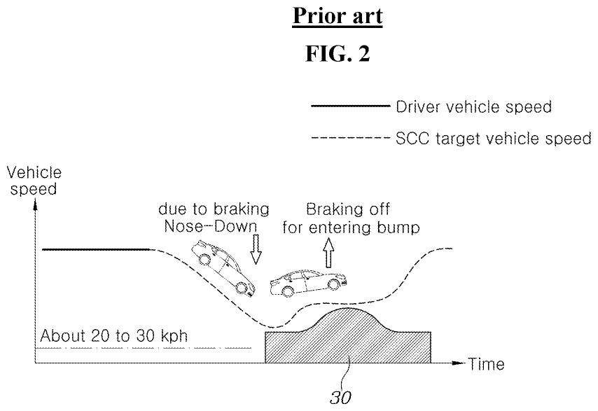

Here, the situation requiring intervention of the hybrid control unit 240 may mean a situation in which the presence of the bump 30 in front is recognized. In such a situation, when powertrain control is performed by the smart cruise control unit 260, ride comfort deterioration described above with reference to FIG. 1 may occur. In the present embodiment, the hybrid control unit 240 may perform powertrain control instead of the smart cruise control unit 260 in such a situation.

However, the configuration shown in FIG. 5 is based on an electric vehicle and it is apparent to those skilled in the art that the lower components 322, 323 and 324 of the hybrid control unit 240 may be included in another control unit (for example, the smart cruise control unit 260) that can transmit a determined required torque to the powertrain or may be implemented as a separate control unit for this function in a vehicle other than electric vehicles.

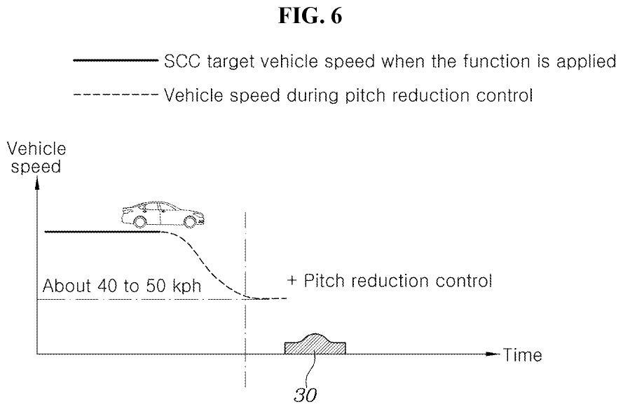

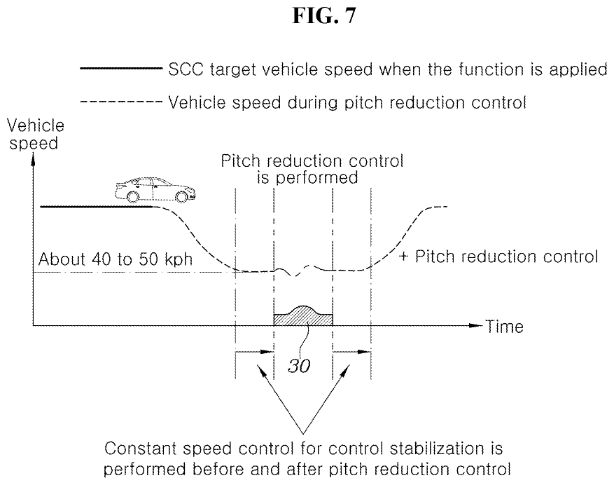

Hereinafter, a pitch reduction control process based on the system described above with reference to FIG. 5 will be described with reference to FIGS. 6 and 7.

FIGS. 6 and 7 are diagrams for describing target speed determination and pitch reduction control of the smart cruise control function in smart cruise control according to an embodiment of the present disclosure.

Referring to FIG. 6, when a bump 30 is detected in a state in which the smart cruise control function is set, the smart cruise control unit 260 may determine a target speed of the smart cruise control function. Here, target speed determination of the smart cruise control unit 260 may be associated with pitch reduction control of the hybrid control unit 240. According to an embodiment, the target speed may be set through a user setting mode (USM) function of allowing a user to set a target speed according to personal convenience. For example, when target speeds of stages 1 and 2 are 40 kph and 50 kph, a target speed can be determined as 40 kph when the user sets stage 1 through the USM function.

Accordingly, the hybrid control unit 240 may control the vehicle speed to become a predetermined target speed and may control the vehicle to enter the bump 30 while traveling at a constant speed for a predetermined time.

The reason why such constant speed traveling is necessary will be described below.

When disturbances such as deceleration and rapid acceleration of a vehicle occur, the disturbances may act as a large vibration component in calculating pitch. For this reason, an error may be generated at the time of determining a pitch rate, which will be described later, and an error may be generated in a pitch result value. In order to prevent such a situation from occurring, the hybrid control unit 240 controls the vehicle such that the vehicle travels at a constant speed corresponding to a target speed, and thus it is possible to stabilize the pitch by reducing an error in determination of the pitch rate.

On the other hand, the smart cruise control unit 260 may determine a distance to the bump 30 and control the vehicle speed to become the target speed on the basis of the determined distance such that the vehicle can travel at a constant speed corresponding to the target speed for a predetermined time before entering the bump 30. Through constant speed traveling for a predetermined time before entering the bump 30, the hybrid control unit 240 can stably determine entry conditions for pitch reduction control, which will be described later.

Such a constant speed traveling state may be maintained for a predetermined time even after passing over the bump 30. This will be described with reference to FIG. 7.

Referring to FIG. 7, the vehicle may travel at a constant speed for a predetermined time at the determined target speed. When the vehicle enters the bump 30, pitch reduction control may be performed.

More specifically, the hybrid control unit 240 may perform pitch reduction control through motor torque control starting when the vehicle enters the bump 30 until the vehicle passes over the bump 30, and may determine the pitch rate prior to this.

First, the relationship among a pitch rate, a longitudinal acceleration, a wheel speed, and the distance from the center of a wheel to a longitudinal acceleration sensor will be described.

aₓ=\dot{v}_{w}+d_{w}\ddot{θ}−gθ Equation 1:.

(θ is pitch, aₓ is a longitudinal acceleration, v_{w} is a wheel speed, and d_{w} is a distance from the center of a wheel to a longitudinal acceleration sensor)

Referring to Equation 1, the hybrid control unit 240 may determine an estimated value of the pitch rate by pseudo-integrating the difference between the wheel acceleration and the longitudinal acceleration calculated from the wheel speed. A wheel speed sensor may measure the wheel speed v_{w} of a vehicle, and the longitudinal acceleration sensor may measure the longitudinal acceleration aₓ that accelerates or decelerates the vehicle by operating in parallel to a traveling direction of the vehicle. Further, the wheel acceleration may be calculated by differentiating the wheel speed v_{w}. Here, the pitch rate is a differential value of the pitch.

In addition, pitch reduction control based on the pitch rate determined by Equation 1 may be performed as follows.

u_{raw}=aₓ−\dot{v}_{w}=d_{w}\ddot{θ}−gθ Equation 2:.

(u_{raw} is an acceleration difference, aₓ is a longitudinal acceleration, v_{w} is a wheel speed, d_{w} is the distance from the center of a wheel to a longitudinal acceleration sensor, and g is acceleration due to gravity)

Referring to Equation 2, it is necessary to improve the accuracy of the pitch rate estimation value by removing phenomena caused by components other than a pitch motion in advance before performing integration. To this end, correction may be performed by subtracting the arithmetic mean of the difference between the longitudinal acceleration and the wheel acceleration measured in a wide section compared to the pitch motion from the difference between the measured longitudinal acceleration and wheel acceleration, thereby minimizing reflection of an offset component or a gravitational acceleration component in the pitch rate estimation value.

If integration is performed at the pitch rate without removing the offset component or the gravitational acceleration component, the integration output diverges and saturates due to accumulation of the offset component over time, making it difficult to accurately estimate the pitch rate. Accordingly, it is possible to accurately estimate the pitch rate by removing and correcting such an offset component in advance and then performing integration.

Meanwhile, the hybrid control unit 240 may perform pitch reduction control when preset control entry conditions are satisfied. This is because the hybrid control unit 240 can improve the accuracy of the pitch estimation value only when the control entry conditions are satisfied. A plurality of control entry conditions may be set and may include, for example, a bump detection condition, a vehicle speed condition, a shift condition, a system interference condition, and a battery state of charge (SOC) condition. The above-described control entry conditions are exemplary and are not necessarily limited thereto, and all conditions necessary for effective pitch reduction control may be included therein.

Here, the hybrid control unit 240 may perform pitch reduction control only when all of the plurality of control entry conditions are satisfied. More specifically, pitch reduction control may be performed when a state in which the bump 30 is detected, a state in which the vehicle is traveling at the target speed determined by the smart cruise control unit 260 before entering the bump 30, a state in which the gear is set to a shift mode, a state in which there is no interference in the system, and a state in which the battery has been charged to a minimum SOC for driving and pitch reduction control are all satisfied.

Meanwhile, when the above-described control entry conditions are satisfied and thus pitch reduction control is performed, the hybrid control unit 240 may stop pitch rate determination and perform additional deceleration when at least one prohibition condition is satisfied. This is because, if at least one prohibition condition is satisfied, the accuracy of the pitch estimation value of the hybrid control unit 240 may decrease. A plurality of prohibition conditions may be set and may include, for example, a stopping and braking condition, a sudden torque change condition, a turning condition, a terrain mode condition, and a slip condition due to a moving up/down and driving. The above-mentioned prohibition conditions are exemplary and not necessarily limited thereto, and the type of a condition is not limited as long as the condition prevents effective performance of pitch reduction control.

Here, when any one of the plurality of prohibition conditions is satisfied, the hybrid control unit 240 may stop pitch rate determination and perform additional deceleration. More specifically, in any one of a state in which the vehicle is stopped or braked, a state in which an accelerator pedal position sensor (APS) value has increased, a state in which the vehicle is turning, a state in which a road surface condition is poor, a state in which a road surface is inclined, and a state in which the vehicle is sliding, the hybrid control unit 240 may stop pitch rate determination and may additionally decelerate the vehicle to provide a smooth ride to the driver in a state in which pitch reduction control is not performed.

Thereafter, the hybrid control unit 240 may control the motor torque such that the vehicle travels at a constant speed corresponding to the target speed after passing over the bump 30. Here, constant speed traveling may be performed for a predetermined time after passing over the bump 30. Thereafter, the smart cruise control function may be performed at a preset target speed.

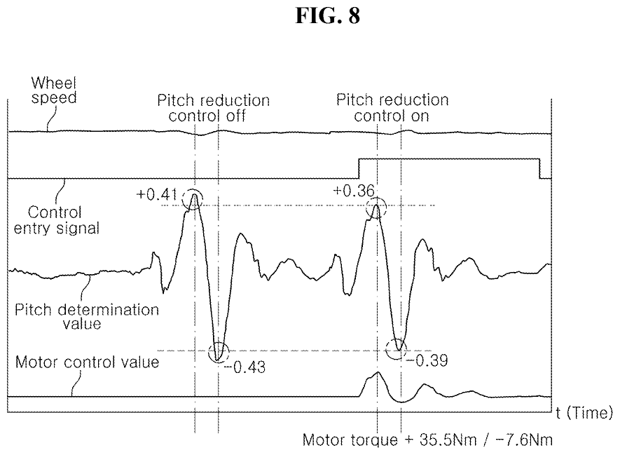

A difference between on and off of pitch reduction control of the hybrid control unit 240 will be described with reference to FIG. 8.

FIG. 8 is a graph showing pitch reduction control on/off of the hybrid control unit 240 according to an embodiment of the present disclosure. FIG. 8 shows results obtained when the vehicle according to the embodiment travels on bumps of the same type installed at predetermined intervals, and pitch reduction control is not performed when the vehicle passes over a front bump and pitch reduction control is performed when the vehicle passes over a rear bump.

Referring to the left part of the graph of FIG. 8, when the hybrid control unit 240 does not perform pitch reduction control, motor torque control for reducing pitch variation occurring when the vehicle enters the bump 30 is not performed. However, referring to the right part of the graph of FIG. 8, the hybrid control unit 240 may perform control such that torque control in the positive (+) direction for pitch reduction is added when the pitch value increases and torque control in the negative (−) direction is added when the pitch value decreases to achieve pitch reduction control. As a result, when the hybrid control unit 240 performs pitch reduction control, the amplitude of pitch estimation value decreases compared to the case where pitch reduction control is not performed, thereby improving ride comfort.

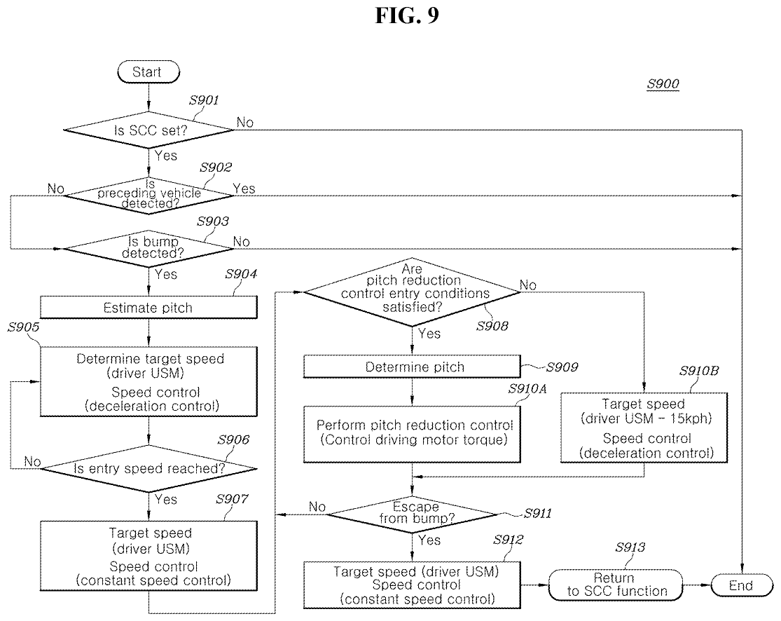

A smart cruise control method according to an embodiment will be described with reference to FIG. 9 based on the above-described configuration of the electric vehicle.

FIG. 9 is a flowchart S900 illustrating an example of a smart cruise control process according to an embodiment of the present disclosure.

First, it may be determined whether the smart cruise control function of the vehicle is set at S901. If the smart cruise control function is set (YES in S901), a vehicle in front of the vehicle that is traveling may be detected first at S902. When the preceding vehicle is not detected (NO in S902), a bump 30 may be detected at S903.

When the bump 30 is detected (YES in S903), pitch estimation of the hybrid control unit 240 is started, which may be performed throughout the control process at S904. Further, the smart cruise control unit 260 may determine a target speed at S905. Thereafter, if the target speed is the same as a speed when the vehicle enters the bump 30 (YES in S906), the hybrid control unit 240 may control the vehicle such that the vehicle travels at a constant speed corresponding to the target speed and performs the smart cruise control function at S907. According to the above-described USM function, the user may set the target speed according to personal convenience.

Thereafter, the hybrid control unit 240 may determine whether preset control entry conditions are satisfied at S908. When the preset control entry conditions are satisfied (YES in S908), the hybrid control unit 240 may determine a pitch rate according to the bump 30 at S909 and perform pitch reduction control through motor torque control on the basis of the determined pitch rate at S910A. However, when the preset control entry conditions are not satisfied (NO in S908), the hybrid control unit 240 may control a motor torque to decrease according to the target speed at S910B. Here, when a prohibition condition is additionally satisfied while the hybrid control unit 240 performs pitch reduction control because the aforementioned control entry conditions are satisfied, pitch rate determination may be stopped and additional deceleration may be performed.

Thereafter, it is determined whether the vehicle has passed over the bump 30 at S911, and when it is determined that the vehicle has passed over the bump 30 (YES in S911), the hybrid control unit 240 may control the motor torque such that the vehicle travels at a constant speed corresponding to the target speed at S912. After constant speed traveling, the smart cruise control function may be performed at the target speed set before the road surface deceleration factor is detected at S913.

According to the embodiments described above, it is possible to improve ride comfort and extend the lifespan of a vehicle by reducing the pitch caused by a road surface deceleration factor in the front of the vehicle. In addition, it is possible to reduce the frequency of driver intervention according to cancelation of smart cruise control.

The present disclosure described above can be implemented as computer-readable code on a medium in which a program is recorded. Computer readable media include all kinds of recording devices in which data readable by a computer system is stored. Examples of computer-readable media include a hard disk drive (HDD), a solid state drive (SSD), a silicon disk drive (SDD), a ROM, a RAM, a CD-ROM, a magnetic tape, a floppy disk, an optical data storage device, etc. Accordingly, the above detailed description should not be construed as restrictive in all respects but as exemplary. The scope of the present disclosure should be determined by a reasonable interpretation of the appended claims, and all modifications within the equivalent scope of the present disclosure are within the scope of the present disclosure.

According to various embodiments of the present disclosure as described above, it is possible to improve ride comfort and extend the lifespan of a vehicle by reducing pitch caused by a road surface deceleration factor in the front of the vehicle. In addition, it is possible to reduce the frequency of driver intervention according to cancelation of smart cruise control.

The effects that can be obtained in the present disclosure are not limited to the above-mentioned effects, and other effects which are not mentioned may be clearly understood by those of ordinary skill in the art to which the present disclosure belongs from the description below.

1. A method of controlling a smart cruise control function, comprising:
determining, by a first controller, a target speed of a vehicle that is traveling when a road surface deceleration factor in front of the vehicle is detected;
entering the road surface deceleration factor, by a second controller, while traveling at a constant speed corresponding to the determined target speed; and
performing, by the second controller, pitch reduction control upon entering the road surface deceleration factor.

2. The method of claim 1, wherein the road surface deceleration factor is detected through at least one of a navigation system, lidar, radar, ultrasonic waves, or a camera.

3. The method of claim 1, further comprising traveling, by the second controller, at a constant speed corresponding to the target speed again after passing over the road surface deceleration factor.

4. The method of claim 3, further comprising performing, by the second controller, the smart cruise control function at a set target speed before a road surface deceleration factor is detected after traveling at the constant speed again.

5. The method of claim 1, wherein the performing pitch reduction control comprises:
determining a pitch rate according to the road surface deceleration factor; and
performing pitch reduction control through motor torque control based on the determined pitch rate.

6. The method of claim 5, wherein pitch reduction control is performed when preset control entry conditions are satisfied.

7. The method of claim 6, further comprising stopping, by the second controller, the determination and performing additional deceleration if a prohibition condition is additionally satisfied when the preset control entry conditions are satisfied.

8. The method of claim 1, further comprising:
determining, by the first controller, a distance to the road surface deceleration factor; and
performing speed control to the target speed based on the determined distance such that the vehicle is able to travel at a constant speed corresponding to the target speed for a predetermined time before entering the road surface deceleration factor.

9. The method of claim 1, wherein the road surface deceleration factor comprises at least one of a speed bump or a pothole.

10. A computer-readable recording medium storing a program for executing the method of controlling a smart cruise control function according to claim 1.

11. An electric vehicle providing a smart cruise control function, comprising:
a first controller configured to determine a target speed of a vehicle that is traveling when a road surface deceleration factor in front of the vehicle is detected; and
a second controller configured to control the vehicle such that the vehicle enters the road surface deceleration factor while traveling at a constant speed corresponding to the determined target speed and to perform pitch reduction control when the vehicle enters the road surface deceleration factor.

12. The electric vehicle of claim 11, wherein the second controller is configured to control the vehicle such that the vehicle travels at a constant speed corresponding to the target speed again after passing over the road surface deceleration factor.

13. The electric vehicle of claim 12, wherein the first controller comprises a smart cruise controller, and the second controller is configured to switch control of the smart cruise control function to the first controller when a set target speed is reached before a road surface deceleration factor is detected after the traveling at the constant speed.

14. The electric vehicle of claim 11, wherein the second controller is configured to determine a pitch rate according to the road surface deceleration factor and to perform pitch reduction control through motor torque control based on the determined pitch rate.

15. The electric vehicle of claim 14, wherein the second controller is configured to perform pitch reduction control when preset control entry conditions are satisfied.

16. The electric vehicle of claim 15, wherein the second controller is configured to stop the determination and to perform additional deceleration if a prohibition condition is additionally satisfied when the preset control entry conditions are satisfied.

17. The electric vehicle of claim 11, wherein the first controller is configured to determine a distance to the road surface deceleration factor and to perform speed control to the target speed based on the determined distance such that the vehicle is able to travel at a constant speed corresponding to the target speed for a predetermined time before entering the road surface deceleration factor.
